(19) United States
(12) Patent Application Publication
(10) Pub. No.: US 2021/0104018 A1
(43) Pub. Date: Apr. 8, 2021

(54) METHOD AND APPARATUS FOR ENHANCING RESOLUTION OF IMAGE

(71) Applicant: LG ELECTRONICS INC., Seoul (KR)

(72) Inventors: Seung Hwan MOON, Siheung-si (KR); Young Kwon KIM, Seoul (KR); Hyun Dae CHOI, Seoul (KR); Keum Sung HWANG, Seoul (KR)

(73) Assignee: LG ELECTRONICS INC., Seoul (KR)

(21) Appl. No.: 16/710,600

(22) Filed: Dec. 11, 2019

(30) Foreign Application Priority Data
Oct. 2, 2019 (KR) 10-2019-0122463

(51) Int. Cl. G06T 3/40

(52) U.S. Cl. CPC G06T 3/4053; G06T 3/4046

(57) ABSTRACT

A method for enhancing the resolution of an image according to an embodiment of the present disclosure can include loading image data including a low resolution image and metadata of the image data, analyzing metadata including information related to an image processing artificial neural network to be applied to the low resolution image in the image data, selecting the image processing artificial neural network to be applied to the low resolution image from a plurality of image processing artificial neural networks, based on the metadata, and generating a high resolution image by processing the low resolution image according to the selected image processing artificial neural network. The image processing neural network of the present disclosure can be a deep neural network generated through machine learning, and the input and output of the moving image data can be performed in an Internet of Things (IoT) environment using a 5G network.

### CROSS-REFERENCE TO RELATED APPLICATION

Pursuant to 35 U.S.C. § 119(a), this application claims the benefit of earlier filing date and right of priority to Korean Patent Application No. 10-2019-0122463, filed on Oct. 2, 2019 in the Republic of Korea, the entire disclosure of which is incorporated herein by reference into the present application.

### BACKGROUND

### Technical Field

The present disclosure relates to a method and apparatus for enhancing the resolution of an image. More particularly, the present disclosure relates to a method and apparatus for generating a high resolution image that enhances a processing speed and quality of an image by using a metadata-based image processing neural network on an image for super resolution imaging.

### Description of Related Art

Image processing technology is a technology for performing specific operations on an image in order to enhance the quality of the image or to extract specific information from the image.

Image processing technology can be widely used in various fields, and is one of the core technologies essentially required in fields such as autonomous vehicles, security monitoring systems, video communication, and high-definition video transmission.

With the development of high resolution image sensors, 5G communication networks, and artificial intelligence technology, image processing technology is also being developed, and recently, technology for converting each frame image of low resolution still images and low resolution moving images into high resolution images by using a deep neural network is being attempted.

Currently, a super resolution technology for processing a low resolution image to obtain a high resolution image mainly uses deep learning technology based on an artificial neural network, and structures of various artificial neural networks used in the super resolution are being proposed by active research and development.

The first study to introduce deep learning into the field of single image super resolution (SISR) used three artificial neural network layers, but recently, various attempts that use 20 artificial neural network layers, or change the position of an up sampling module in terms of an artificial neural network framework are being made.

There is a difficulty in that in the selection of any one method among the deep learning super resolutions of various structures, the conversion quality of the low resolution image into the high resolution image can vary according to the type of the learned image.

In Korean Patent Application Publication No. 10-2018-0126362 published on Nov. 27, 2018 (related art 1), disclosed is a technology of sequentially applying a recurrent neural network (RNN) and a convolutional neural network (CNN) to a plurality of input frames constituting a moving image when performing super resolution processing on the moving image.

In the related art 1, the RNN and the CNN are sequentially applied to an input frame without simultaneously inputting consecutive frames into a neural network, in order to solve discontinuous artifacts among a plurality of frames. However, in related art 1, the same CNN method is applied to all frames, and there is thus a shortcoming in that it may not guarantee the same high resolution image conversion quality for all frame images in the moving image composed of various kinds of frame images.

In Korean Patent Application Publication No. 10-2019-0059157 published on May 30, 2019 (related art 2), disclosed is a technology utilizing spatiotemporal information of front and rear adjacent frames without performing a motion compensation process. However, the same CNN method is also applied to all frames in the related art 2.

In order to address the shortcomings described above, there is a need for a solution capable of effectively generating a high resolution image by utilizing a neural network model trained using various methods suitable not only for still images that are different from each other, but also for the various frame images of a moving image.

The above-described related art is technical information that the inventor holds for deriving the present disclosure or is acquired in the derivation process of the present disclosure, and is not necessarily a known technology disclosed to the general public before the application of the present disclosure.

### SUMMARY OF THE DISCLOSURE

An aspect of the present disclosure is to address the shortcoming associated with some related art in which, since the same super resolution processing is performed on all frame images of different still images or moving images using a predetermined single neural network model, the same high resolution image conversion quality may not be ensured for all images.

Another aspect of the present disclosure is to address the shortcoming associated with some related art in which, since super resolution processing is performed using the same artificial neural network model for all frame images of different still images or moving images without considering the content of the image, the super resolution processing is not performed efficiently.

Still another aspect of the present disclosure is to address the shortcoming associated with some related art in which, since super resolution processing is performed using the same artificial neural network model for all frame images of different still images or moving images, which requires a high amount of computation, without considering performance of an image reproducing apparatus, the image reproducing apparatus may not efficiently convert a high resolution image.

An embodiment of the present disclosure can provide a method and an apparatus for enhancing the resolution of an image, in which performance and efficiency of the resolution enhancement are enhanced by performing super resolution processing suitable for each image for each low resolution image in image data.

Another embodiment of the present disclosure can provide a method and an apparatus for enhancing the resolution of an image, in which performance and efficiency of the resolution enhancement are enhanced by performing super resolution processing suitable for each image by reflecting the context of the image.

Still another embodiment of the present disclosure can provide a method and an apparatus capable of efficiently generating metadata including information related to a super resolution model and a weighting factor to be applied to each image frame of moving image data.

A method for enhancing the resolution of an image of an electronic device according to an embodiment of the present disclosure can include loading image data including a low resolution image and metadata of the image data, analyzing metadata including information related to an image processing artificial neural network to be applied to the low resolution image in the image data, selecting the image processing artificial neural network to be applied to the low resolution image from an image processing artificial neural network group including a plurality of image processing artificial neural networks, based on the metadata, and generating a high resolution image by processing the low resolution image according to the selected image processing artificial neural network.

Further, in the method for enhancing the resolution of the image according to this embodiment of the present disclosure, the image data can be moving image data composed of a plurality of low resolution images, and the selecting of the image processing artificial neural network can include selecting different image processing artificial neural networks to be respectively applied to at least two different low resolution images in the moving image data, based on the metadata.

Here, the method for enhancing the resolution of the image can further include, after the generating of the high resolution image, storing the generated high resolution image in a buffer during a predetermined reference time or a predetermined period, and sequentially outputting the high resolution image from the buffer.

Further, in the method for enhancing the resolution of the image according to an embodiment of the present disclosure, the image data can be moving image data composed of a plurality of groups of pictures (GOP), and the selecting of the image processing artificial neural network can include selecting different image processing artificial neural networks to be respectively applied to at least two different groups of pictures in the moving image data, based on the metadata.

Further, in the method for enhancing the resolution of the image according to this embodiment of the present disclosure, the metadata can include a first weighting factor and a second weighting factor respectively related to a first image processing artificial neural network and a second image processing artificial neural network, and the selecting of the image processing artificial neural network can include selecting the first image processing artificial neural network and the second image processing artificial neural network to be applied to the low resolution image, based on the metadata, and the generating the high resolution image can include generating a first intermediate high resolution image and a second intermediate high resolution image by respectively applying the first image processing artificial neural network and the second image processing artificial neural network to the low resolution image, and generating the high resolution image by synthesizing an image of the result of applying the first weighting factor to the first intermediate high resolution image and an image of the result of applying the second weighting factor to the second intermediate high resolution image.

Further, in the method for enhancing the resolution of the image according to this embodiment of the present disclosure, the method can further include, before the analyzing of the metadata, transmitting the image data to a metadata generation server apparatus and receiving the metadata including information related to the image processing artificial neural network to be applied to the low resolution image in the image data.

A computer readable recording medium in which a method for enhancing the resolution of an image according to an embodiment of the present disclosure is stored can be a computer readable recording medium in which a computer program for executing any one method of the above described methods is stored.

A method for generating metadata for enhancing the resolution of an image of a server apparatus according to another embodiment of the present disclosure can include receiving, from a user terminal, image data including a low resolution image, generating a plurality of high resolution images by processing the low resolution image according to a plurality of image processing artificial neural networks, determining at least one image processing artificial neural network to be applied to the low resolution image by comparing the quality of the plurality of high resolution images, and generating metadata including identification information of the determined image processing artificial neural network.

Further, in the method for generating metadata for enhancing the resolution of the image of the server apparatus according to this embodiment of the present disclosure, the generating of the plurality of high resolution images can include determining the context of the low resolution image by processing the low resolution image according to an artificial neural network for determining the context, and generating the high resolution images by processing the low resolution image according to the plurality of image processing artificial neural networks previously set in relation to the determined context.

Further, in the method for generating metadata for enhancing the resolution of the image of the server apparatus according to this embodiment of the present disclosure, the method can include, before the generating the plurality of high resolution images, receiving performance information of the user terminal and selecting a plurality of image processing artificial neural networks based on the performance information, and the generating the plurality of high resolution images can include generating the plurality of high resolution images by processing the low resolution image according to the selected plurality of image processing artificial neural networks.

An image resolution enhancement apparatus according to another embodiment of the present disclosure can include a processor, and a memory electrically connected with the processor and configured to store metadata including at least one instruction performed in the processor, a parameter of an image processing artificial neural network model, or information related to the image processing artificial neural network model to be applied to a low resolution image in image data. The memory can store codes that cause the processor to generate a high resolution image by loading the image data including a low resolution image, and processing the low resolution image according to an image processing artificial neural network model to be applied to the low resolution image from an image processing artificial neural network model group including a plurality of image processing artificial neural network models based on the metadata, when executed through the processor.

Here, the metadata can include a first weighting factor and a second weighting factor respectively related to a first image processing artificial neural network and a second image processing artificial neural network, and the memory can further store codes that cause generation of a first intermediate high resolution image and a second intermediate high resolution image by respectively applying the first image processing artificial neural network and the second image processing artificial neural network to the low resolution image, and generation of the high resolution image by synthesizing an image of the result of applying the first weighting factor to the first intermediate high resolution image and an image of the result of applying the second weighting factor to the second intermediate high resolution image, based on the metadata.

Further, in the image resolution enhancement apparatus according to this embodiment of the present disclosure, the image data can be moving image data composed of a plurality of low resolution images, and the memory can further store codes that cause generation of the high resolution image by processing the low resolution image according to at least two different image processing artificial neural network models to be respectively applied to at least two different low resolution images in the moving image data, or to be respectively applied to at least two different groups of pictures (GOP), based on the metadata.

Further, in the image resolution enhancement apparatus according to this embodiment of the present disclosure, the memory can further store codes that cause generation of a plurality of artificial neural network instances based on the plurality of image processing artificial neural network models, and delivery of the low resolution image to any one instance among the plurality of artificial neural network instances based on the metadata.

Further, in the image resolution enhancement apparatus according to this embodiment of the present disclosure, the memory can further store codes that cause selective generation of an artificial neural network instance based on any one artificial neural network model among the plurality of image processing artificial neural network models based on the metadata, and delivery of the low resolution image to the generated artificial neural network instance.

Further, in the image resolution enhancement apparatus according to this embodiment of the present disclosure, the metadata can further include a hash value related to the image data, and the memory can further store codes that cause comparison of a hash value included in the metadata with a hash value of the loaded image data.

A metadata generation server apparatus according to another embodiment of the present disclosure can include a processor, and a memory electrically connected with the processor and configured to store at least one instruction performed in the processor and a parameter of a plurality of image processing artificial neural networks. The memory can store codes that cause determination of at least one image processing artificial neural network to be applied to a low resolution image by comparing high resolution images generated by processing the low resolution image included in the received image data according to the plurality of image processing artificial neural networks, and generation of metadata including identification information of the determined image processing artificial neural network.

Here, the image data can be moving image data composed of a plurality of groups of pictures (GOP), and the memory can further store codes that cause generation of the high resolution images by processing the low resolution image corresponding to an intra frame of the group of pictures according to the plurality of image processing artificial neural networks, and storage of identification information of the determined image processing artificial neural network in the metadata for each group of picture.

In the metadata generation server apparatus according to this embodiment of the present disclosure, the memory can further store codes that cause storage of the identification information of the artificial neural network with a tag previously set as the metadata in a header area of the image data, or in a manifest file related to the image data.

The apparatus and method for enhancing the resolution of the image according to embodiments of the present disclosure can use different image processing neural networks for each frame image of the still image or the moving image, thereby enhancing the quality of the resolution enhancement when converting different images into high resolution.

Further, according to the embodiments of the present disclosure, an artificial neural network model suitable for each image can be applied based on the content of the image, thereby enhancing performance and efficiency of resolution enhancement when converting the image into high resolution.

Further, according to the embodiments of the present disclosure, the image processing neural network to perform the super resolution processing can be selected considering performance of the image reproducing apparatus to enhance resolution, thereby enhancing the resolution of the image regardless of performance of the image reproducing apparatus.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of an environment for performing a method for enhancing an image resolution according to an embodiment of the present disclosure;

FIG. 2 is a diagram illustrating a system for generating an image processing neural network and metadata according to an embodiment of the present disclosure;

FIG. 3 is a diagram for explaining an image processing neural network according to an embodiment of the present disclosure;

FIG. 4 is a flowchart for explaining a method for enhancing an image resolution of an image reproducing apparatus according to an embodiment of the present disclosure;

FIG. 5 is a diagram for explaining a metadata structure of a manifest file according to an embodiment of the present disclosure;

FIGS. 6 and 7 are diagrams for explaining a process in which a method for enhancing an image resolution according to an embodiment of the present disclosure is performed on a moving image;

FIG. 8 is a flowchart for explaining a method for generating metadata of a metadata generation server according to an embodiment of the present disclosure;

FIG. 9 is a diagram for explaining a process in which a method for generating metadata of a metadata generation server according to an embodiment of the present disclosure is performed on a moving image;

FIG. 10 is a flowchart for explaining a method for generating metadata of a metadata generation server according to an embodiment of the present disclosure; and

FIG. 11 is a diagram for explaining a process in which a method for generating metadata of a metadata generation server according to an embodiment of the present disclosure is performed on a moving image.

### DETAILED DESCRIPTION OF THE EMBODIMENTS

The advantages and features of the present disclosure and methods to achieve them will be apparent from the embodiments described below in detail in conjunction with the accompanying drawings. However, the description of particular exemplary embodiments is not intended to limit the present disclosure to the particular exemplary embodiments disclosed herein, but on the contrary, it should be understood that the present disclosure is to cover all modifications, equivalents and alternatives falling within the spirit and scope of the present disclosure. The exemplary embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification if it is determined that such details are not necessary to obtain a complete understanding of the present disclosure.

The terminology used herein is used for the purpose of describing particular exemplary embodiments only and is not intended to be limiting. As used herein, the articles “a,” “an,” and “the,” include plural referents unless the context clearly dictates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally used only to distinguish one element from another.

Hereinafter, embodiments of the present disclosure will be described in detail with reference to the accompanying drawings. Like reference numerals designate like elements throughout the specification, and overlapping descriptions of the elements will be omitted.

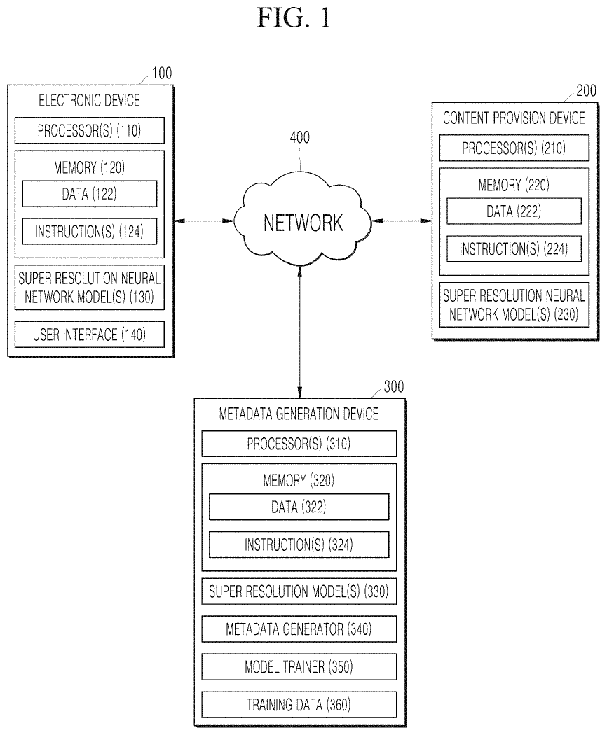

FIG. 1 is an exemplary diagram of an environment for performing a method for enhancing an image resolution according to an embodiment of the present disclosure.

Referring to FIG. 1, an environment for performing a method for enhancing an image resolution according to an embodiment of the present disclosure can include an electronic device 100, a content provision device 200, a metadata generation device 300, and a network 400 that enables these devices to communicate with each other.

The electronic device 100 can support Internet of Things (IoT), Internet of Everything (IoE), Internet of Small Things (IoST), and the like, and can support communication such as machine to machine (M2M) communication and device to device (D2D) communication.

The electronic device 100 can determine an image resolution enhancement method by using big data, an artificial intelligence (AI) algorithm, and/or a machine learning algorithm in a 5G environment connected for the IoT.

The electronic device 100 can be, for example, any kind of computation device such as a personal computer, a smartphone, a tablet, a game console, a projector, a wearable device (for example, a smart glass, a head mounted display (HMD), a set top box (STB), a desktop computer, a digital signage, a smart TV, or a network attached storage (NAS), and can also be implemented as a fixed device or a mobile device.

Further, the electronic device 100 can be implemented as various forms of home appliances for household use, and can be also applied to a stationary or mobile robot.

The electronic device 100 can include a wireless communicator capable of transmitting or receiving data in a 5G environment connected for the IoT. The wireless communicator can include at least one of a broadcast receiving module, a mobile communication module, a wireless internet module, a short-range communication module, or a position information module.

The broadcast receiving module receives a broadcast signal and/or broadcast related information from an external broadcast management server through a broadcast channel

The mobile communication module transmits and receives a radio signal to and from at least one of a base station, an external terminal, a server, and the like on a mobile communication network established according to technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and the like) and 5G (Generation) communication systems.

The wireless internet module refers to a module for wireless internet access, and can be embedded in the user terminal 100 or externally. The wireless internet module can transmit and receive wireless signals via a communication network according to wireless internet technologies.

The wireless internet technologies can include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range communication module is for short-range communication, and can support the short-range communication by using at least one of Bluetooth (Bluetooth$\hat{ }™$), Radio Frequency Identification (RFID), Infrared Data Association (IrDA),

Ultra Wideband (UWB), ZigBee, Near Field Communication (NFC), Wireless-Fidelity (WiFi), Wi-Fi Direct, and Wireless Universal Serial Bus (Wireless USB) technologies.

The position information module is a module for obtaining a position (or current position) of the mobile electronic device, and a representative example thereof is a Global Positioning System (GPS) module or a Wireless Fidelity (WiFi) module. For example, if the electronic device utilizes the GPS module, the electronic device can obtain a position of the mobile electronic device by using a signal transmitted from a GPS satellite.

The electronic device 100 can include one or more processors 110 and a memory 120.

The one or more processors 110 can include all kinds of devices, for example, an MCU, a GPU, and an AI accelerator chip, capable of processing data. Here, the “processor” may, for example, refer to a data processing device embedded in hardware, which has a physically structured circuitry to perform a function represented by codes or instructions contained in a program.

As examples of the data processing device embedded in hardware, a microprocessor, a central processor (CPU), a processor core, a multiprocessor, an application-specific integrated circuit (ASIC), a field programmable gate array (FPGA), and the like can be included, but the scope of the present disclosure is not limited thereto.

The processor 110 can determine or predict at least one executable operation of the electronic device 100 based on information which is determined or generated using the data analysis and the machine learning algorithm. To this end, the processor 180 can control the electronic device to execute an operation predicted among the at least one executable operation, or an operation determined to be preferable.

The processor 110 can perform various functions which implement intelligent emulation (that is, a knowledge based system, an inference system, and a knowledge acquisition system). This can be applied to various types of systems (for example, a fuzzy logic system) including an adaptive system, a machine learning system, and an artificial neural network.

The electronic device 100 can include an output interface configured to output data having processed the result performed by the processor 110.

The output interface is for generating an output related to visual, auditory, or tactile senses, and can include at least one of a display, a sound output module, a haptic module, of an optical output module.

The display displays (outputs) information processed by the electronic device 100. For example, the display can display execution screen information of an application program driven in the electronic device 100 and user interface (UI) and graphic user interface (GUI) information in according with the execution screen information.

The display can implement a touch screen by forming a layered structure or being integrated with touch sensors. Such a touch screen can provide an output interface between the electronic device 100 and the user while functioning as a user input means for providing an input interface between the electronic device 100 and the user.

The memory 120 can include one or more non-transitory storage media such as RAM, ROM, EEPROM, EPROM, flash memory devices, and magnetic disks. The memory 120 can store instructions 124 for causing the electronic device 100 to perform operations when executed by the data 122 and the processors 110.

Further, the electronic device 100 can include a user interface 140, and can thereby receive instructions from a user and also deliver output information to the user. The user interface 140 can include various input means such as a keyboard, a mouse, a touch screen, a microphone, and a camera, and various output means such as a monitor, a speaker, and a display.

The electronic device 100 can include an interface configured to serve as a path to various types of external devices connected to the electronic device 100. Such an interface can include at least one among a wired/wireless headset port, an external charger port, a wired/wireless data port, a memory card port, a port connecting a device provided with an identification module, an audio input/output (I/O) port, a video input/output (I/O) port, and an earphone port. In response to an external device being connected to the interface, the electronic device 100 can perform an appropriate control related to the connected external device.

The user can select a moving image to be processed in the electronic device 100 through the user interface 140. For example, the user can select a moving image for which the resolution is desired to be enhanced through a mouse, a keyboard, or a touch screen.

The user interface 140 can be a mechanical input means (or a mechanical key, for example, a button, a dome switch, a jog wheel, a jog switch, or the like positioned at the front/rear surface or side surface of the electronic device 100) and a touch input means. For example, the touch type input interface can be formed by a virtual key, a soft key, or a visual key which is disposed on the touch screen through a software process, or a touch key which is disposed on a portion other than the touch screen.

In an embodiment, the electronic device 100 can also store or include a plurality of super resolution (SR) models 130 to which artificial intelligence technology is applied. For example, the super resolution models 130 to which artificial intelligence technology is applied can be, or include, various learning models, such as a deep neural network or other types of machine learning models.

In this specification, the artificial neural network which is trained using training data to determine parameters can be referred to as a learning model or a trained model.

Meanwhile, the super resolution models 130 can be implemented in hardware, software, or a combination of hardware and software. When some or all of the super resolution models are implemented in software, one or more instructions constituting the super resolution model can be stored in the memory 120.

Artificial intelligence (AI) is an area of computer engineering science and information technology that studies methods to make computers mimic intelligent human behaviors such as reasoning, learning, self-enhancing, and the like.

Further, artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed

Specifically, machine learning can be a technology for researching and constructing a system for learning, predicting, and enhancing its own performance based on empirical data and an algorithm for the same. Machine learning algorithms, rather than only executing rigidly set static program commands, can be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network can include a model that represents the probabilistic relationship (conditional independence) among a set of variables. Bayesian network can be appropriate for data mining via unsupervised learning.

SVM can include a supervised learning model for pattern detection and data analysis, heavily used in classification and regression analysis.

ANN is a data processing system modeled after the mechanism of biological neurons and interneuron connections, in which a number of neurons, referred to as nodes or processing elements, are interconnected in layers.

ANNs are models used in machine learning and can include statistical learning algorithms conceived from biological neural networks (particularly of the brain in the central nervous system of an animal) in machine learning and cognitive science.

ANNs can refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ can be used interchangeably herein.

An ANN can include a number of layers, each including a number of neurons. Furthermore, the ANN can include synapses that connect the neurons to one another.

An ANN can be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN can be classified as a single-layer neural network or a multi-layer neural network, based on the number of layers therein.

In general, a single-layer neural network can include an input layer and an output layer.

In general, a multi-layer neural network can include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer can be the most representative type of artificial neural network which enables deep learning, which is one machine learning technique.

An ANN can be trained using training data. Here, the training can refer to the process of determining parameters of the artificial neural network by using the training data, to perform tasks such as classification, regression analysis, and clustering of inputted data. Such parameters of the artificial neural network can include synaptic weights and biases applied to neurons.

An artificial neural network trained using training data can classify or cluster inputted data according to a pattern within the inputted data.

Throughout the present specification, an artificial neural network trained using training data can be referred to as a trained model.

Hereinbelow, learning paradigms of an artificial neural network will be described in detail.

Learning paradigms, in which an artificial neural network operates, can be classified into supervised learning, unsupervised learning, semi-supervised learning, and reinforcement learning.

Supervised learning is a machine learning method that derives a single function from the training data.

Among the functions that can be thus derived, a function that outputs a continuous range of values can be referred to as a regressor, and a function that predicts and outputs the class of an input vector can be referred to as a classifier.

In supervised learning, an artificial neural network can be trained with training data that has been given a label.

Here, the label can refer to a target answer (or a result value) to be guessed by the artificial neural network when the training data is inputted to the artificial neural network.

Throughout the present specification, the target answer (or a result value) to be guessed by the artificial neural network when the training data is inputted can be referred to as a label or labeling data.

Throughout the present specification, assigning one or more labels to training data in order to train an artificial neural network can be referred to as labeling the training data with labeling data.

Training data and labels corresponding to the training data together can form a single training set, and as such, they can be inputted to an artificial neural network as a training set.

The training data can exhibit a number of features, and the training data being labeled with the labels can be interpreted as the features exhibited by the training data being labeled with the labels. In this case, the training data can represent a feature of an input object as a vector.

Using training data and labeling data together, the artificial neural network can derive a correlation function between the training data and the labeling data. Then, through evaluation of the function derived from the artificial neural network, a parameter of the artificial neural network can be determined (optimized).

Unsupervised learning is a machine learning method that learns from training data that has not been given a label.

More specifically, unsupervised learning can be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, enhance performance through competing with each other.

The generator can be a model generating new data that generates new data based on true data.

The discriminator can be a model recognizing patterns in data that determines whether inputted data is from the true data or from the new data generated by the generator.

Furthermore, the generator can receive and learn from data that has failed to fool the discriminator, while the discriminator can receive and learn from data that has succeeded in fooling the discriminator. Accordingly, the generator can evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE can include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer can be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training The fact that when representing information, the hidden layer is able to reconstruct the inputted data as output by using fewer neurons than the input layer can indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique can be used advantageously when the cost associated with the labeling process is high.

Reinforcement learning can be based on a theory that given the condition under which a reinforcement learning agent can determine what action to choose at each time instance, the agent can find an optimal path to a solution solely based on experience without reference to data.

Reinforcement learning can be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network can be determined by a number of factors, including the number of hidden layers, the number of hidden nodes included in each hidden layer, input feature vectors, target feature vectors, and so forth.

Hyperparameters can include various parameters which need to be initially set for learning, much like the initial values of model parameters. Also, the model parameters can include various parameters sought to be determined through learning.

For instance, the hyperparameters can include initial values of weights and biases between nodes, mini-batch size, iteration number, learning rate, and so forth. Furthermore, the model parameters can include a weight between nodes, a bias between nodes, and so forth.

Loss function can be used as an index (reference) in determining an optimal model parameter during the learning process of an artificial neural network. Learning in the artificial neural network involves a process of adjusting model parameters so as to reduce the loss function, and the purpose of learning can be to determine the model parameters that minimize the loss function.

Loss functions typically use means squared error (MSE) or cross entropy error (CEE), but the present disclosure is not limited thereto.

Cross-entropy error can be used when a true label is one-hot encoded. One-hot encoding can include an encoding method in which among given neurons, only those corresponding to a target answer are given 1 as a true label value, while those neurons that do not correspond to the target answer are given 0 as a true label value.

In machine learning or deep learning, learning optimization algorithms can be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted can be referred to as a step direction, and a size by which the model parameters are to be adjusted can be referred to as a step size.

Here, the step size can mean a learning rate.

GD obtains a slope of the cost function through use of partial differential equations, using each of model parameters, and updates the model parameters by adjusting the model parameters by a learning rate in the direction of the slope.

SGD can include a method that separates the training dataset into mini batches, and by performing gradient descent for each of these mini batches, increases the frequency of gradient descent.

Adagrad, AdaDelta and RMSProp can include methods that increase optimization accuracy in SGD by adjusting the step size, and can also include methods that increase optimization accuracy in SGD by adjusting the momentum and step direction. Adam can include a method that combines momentum and RMSProp and increases optimization accuracy in SGD by adjusting the step size and step direction. Nadam can include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

The super resolution models 130 to which artificial intelligence technology as described above is applied can be first generated through a training operation by the metadata generation device 300, and stored in the content provision device 200 and transmitted to the electronic device 100 through the network 400.

The metadata generation device 300 or the content provision device 200 can transmit the plurality of super resolution models trained by machine learning or deep learning to the electronic device 100 periodically or by request.

The super resolution models 130 can be an image processing neural network, and can be a learning model trained to process a frame image of a still image or a moving image in order to output a high resolution moving image if a low resolution moving image is inputted.

Typically, the super resolution models 130 can complete a training operation in the metadata generation device 300 and then be transmitted to and stored in the content provision device 200 or the electronic device 100 in a state where it can be applied to a low resolution moving image, but in some embodiments, the super resolution models 130 can also be updated or upgraded through additional training at the request of the electronic device 100 or the content provision device 200.

Meanwhile, the super resolution models 130 stored in the electronic device 100 can be some of the super resolution models 130 generated in the metadata generation device 300. As necessary, new super resolution models can be generated by the metadata generation device 300 and delivered to the content provision device 200 or the electronic device 100.

As another example, the super resolution models 130 can be stored in the content provision device 200 instead of being stored in the electronic device 100, and can also provide a function necessary for the electronic device 100 in the form of a streaming service.

The content provision device 200 can include processors 210 and a memory 220, and in general, can have a larger processing capability and a larger memory capacity than those of the electronic device 100. Accordingly, according to the implementation of the system, the content provision device 200 can also be configured such that heavy super resolution models 230 that require relatively more processing capability for the application are stored in the content provision device 200, and the lightweight super resolution models 130 that require relatively less processing capability for the application are stored in the electronic device 100.

The electronic device 100 can apply the super resolution models that are set to be applied to the corresponding image based on metadata according to the image to be processed among various super resolution models 130 stored for the frame image of a still image or a moving image (hereinafter, both described as an “image”). For example, the electronic device 100 can apply a specific super resolution model to some images in the moving image and apply a different super resolution model to other images in the same moving image. As another example, when set to apply different super resolution models of the lightweight super resolution model and the heavy super resolution model to the metadata with respect to different images of the same moving image, the electronic device 100 can also be configured to use the super resolution model 130 stored in the electronic device 100 when the lightweight super resolution model 130 is required, and to use the super resolution model 230 stored in the content provision device 200 when the heavy super resolution model 230 is required.

The metadata is a manifest file received from the content provision device 200 or the metadata generation device 300 in relation to the corresponding content for each still image or moving image, or can be stored and transmitted in a specific field of the corresponding still image data or moving image data, and is described in detail below.

The super resolution models 130 and 230 included in the electronic device 100 or the content provision device 200 can be an image processing neural network generated by the metadata generation device 300.

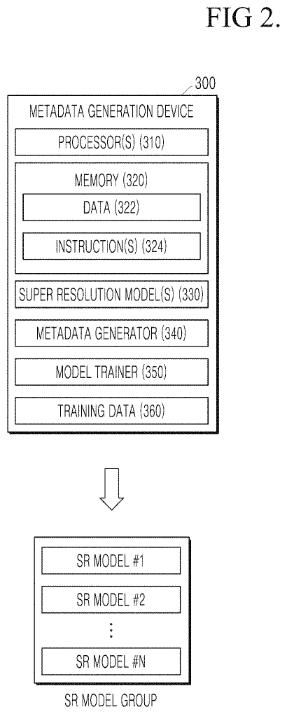

FIG. 2 is a diagram illustrating a system for generating an image processing neural network according to an embodiment of the present disclosure.

The metadata generation device 300 can include one or more processors 310 and a memory 320. The metadata generation device 300 can include a metadata generator 340 configured to generate metadata including identification information of the super resolution models selected based on a plurality of super resolution models 330 applicable to the image and the result of applying the super resolution models 330 to the still image or the moving image. Further, the metadata generation device 300 can include a model trainer 350 and training data 360 for training machine learning models.

The metadata generation device 300 can be implemented not only by a single server, but also by a multiple of server sets, a cloud server, or a combination thereof.

That is, the metadata generation device 300 can be configured in plural to constitute a set of metadata generation devices (or a cloud server), and at least one metadata generation device 300 included in the set of metadata generation devices can derive a result by analyzing or learning data through distributed processing.

The metadata generation device 300 can generate a plurality of super resolution models having different complexity or structures from each other through the model trainer 350.

For example, an image processing neural network in which a hidden layer has been formed of two layers can be selected for a specific image, but an image processing neural network in which a hidden layer has been formed of four layers can be selected for another image.

Further, the metadata generation device 300 can generate super resolution models having different neural network structures or parameters by training super resolution model using the same learning method but with different kinds of images.

For example, even in the case of the super resolution models generated by using the same learning model, the metadata generating device 300 can generate a super resolution model trained to enhance a resolution based on landscape images and a super resolution model trained to enhance a resolution based on character images. Further, even if training based on the same kind of learning images, the metadata generation device 300 can generate a plurality of super resolution models by using different learning models. In this case, the metadata generation device 300 can classify the super resolution models generated by using the same kind of images based on the kind of the trained learning image into the same super resolution model group, and store the super resolution models therein. Accordingly, the metadata generation device 300 can generate a plurality of super resolution model groups trained using different kinds of images, and transmit them to the content provision device 200 or the electronic device 100.

In an embodiment, the metadata generation device 300 can generate a super resolution model capable of optimally enhancing the resolution of a human image by using the training data 360 with respect to a low resolution image of the corresponding human labeled with a high resolution image of the human Since a viewer is highly interested in the human face in super resolution processing of an image of a specific scene in a moving image or a CCTV moving image, the metadata generation device 300 can generate super resolution models having different performances while having different structures and complexity from each other, capable of enhancing the resolution of the human image.

For example, as neural networks for moving image frame processing that are trained to enhance the resolution of a human image, the metadata generation device 300 can generate super resolution models including neural networks of a different super resolution model and neural networks having different numbers of hidden layers.

The metadata generation device 300 can also generate an image processing neural network having a high complexity that has a long processing time but provides relatively enhanced performance according to an initial configuration of the neural network, and can generate an image processing neural network having a low complexity that provides relatively lower performance but shortens the processing time.

As described above, a super resolution model group including super resolution models having various structures or complexity that can be used in various images can be formed.

Here, it can be understood that the structure or complexity of the image processing neural network is determined by the number of input nodes, the number of features, the number of channels, the number of hidden layers, and the like, and particularly the complexity is higher as the number of features, the number of channels, and the number of hidden layers increase. Further, the neural network can also be referred to as heavy as the number of channels and the number of hidden layers increase. Further, the complexity of the neural network can also be referred to as dimensionality of the neural network.

The performance of the frame resolution enhancement can improve as the complexity of the neural network increases, but the time taken for frame processing can be longer. Conversely, the performance of the frame resolution enhancement can be relatively lower as the neural network is lighter, but the time taken for frame processing can be shorter.

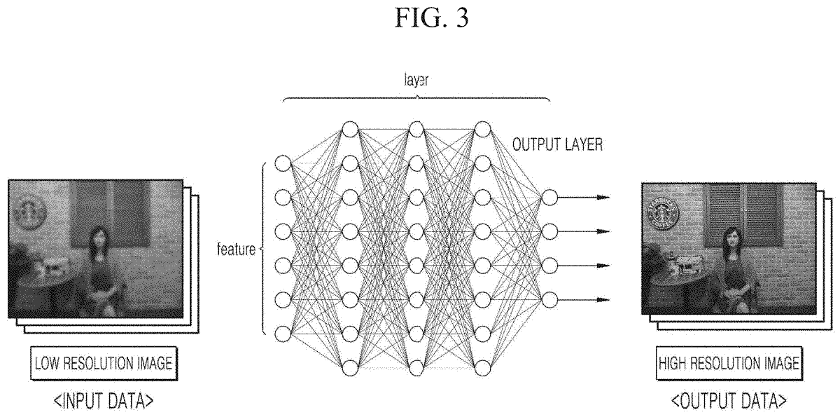

FIG. 3 is a diagram for explaining an image processing neural network according to an embodiment of the present disclosure.

The image processing neural network can be composed of an input layer, a hidden layer, and an output layer. The number of input nodes is defined according to the number of features, and as the number of nodes increases, the complexity or dimensionality of the neural network increases. Further, as the number of hidden layers increases, complexity or dimensionality of the neural network increases.

The number of features, the number of input nodes, the number of hidden layers, and the number of nodes in each layer can be defined by a neural network designer, and as the complexity increases, the processing time can increase but better performance can be exhibited.

Once the initial neural network structure is designed, the neural network can be trained by using training data. To implement a neural network for enhancing the frame resolution, a high resolution original image and a low resolution version of the corresponding image are required. After collecting high resolution original images, the corresponding images can be subjected to distortion processing such as blurring, down sampling such as bicubic down sampling, or noise injection, thereby preparing low resolution images corresponding to the high resolution original images.

In the case of connecting the high resolution original images corresponding to the low resolution images by a label, training data capable of training a neural network for enhancing an image resolution are prepared.

In the case of training the neural network in a supervised learning method through a large amount of training data, an image processing neural network model capable of outputting a high resolution image when a low resolution image is input can be generated.

Here, in the case of using the training data including images of a specific kind of object as training data, an image processing neural network optimized to enhance the resolution of the corresponding object image can be obtained.

Meanwhile, the processing speed and processing performance of the image processing neural network can be in a trade-off relationship, and a designer can change the initial structure of the neural network to generate neural networks for various super resolution models having different processing speeds and processing performances from each other, and to generate a super resolution model applicable to the electronic device 100 having different performances from each other.

The super resolution model can be implemented in hardware, software, or a combination of hardware and software, and when some or all of the super resolution models are implemented in software, the one or more instructions or parameters constituting the super resolution model can be stored in the memories 120, 220, 320.

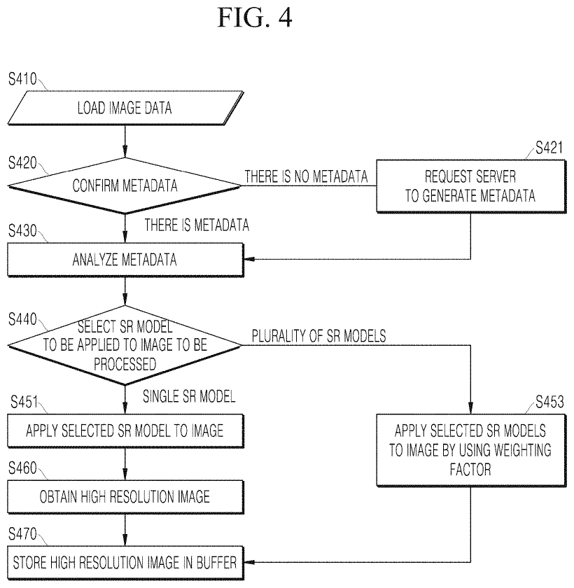

FIG. 4 is a flowchart for explaining a method for enhancing an image resolution of an image resolution enhancement apparatus according to an embodiment of the present disclosure.

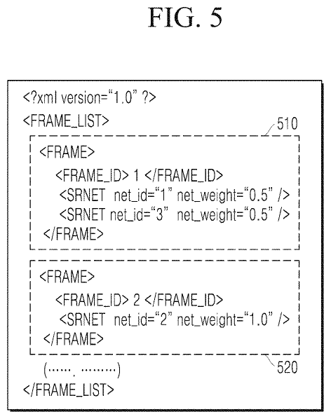

Further, FIGS. 5 to 7 are diagrams for explaining a process in which the method for enhancing an image resolution according to an embodiment of the present disclosure described in FIG. 4 is performed on moving image data.

An image resolution enhancement apparatus can have a configuration as in the electronic device 100 described in FIG. 1. First, the image resolution enhancement apparatus can load image data 610 (step S410). The image data can also be photographed by a device equipped with a camera, and can also be data received through wired or wireless communication from an external device. Further, the image data can be still image data composed of a single image or moving image data composed of a plurality of images.

Further, loading of the image data includes temporarily or non-temporarily storing streaming data received by a real-time streaming method through wired/wireless communication in a memory for applying a super resolution model.

The image resolution enhancement apparatus can also be a general user terminal such as, for example, a computer, a smartphone, or a tablet, and can also be a device serving as a server that receives image data to enhance the resolution of each image and transmits the result to a connected external device (for example, a monitor, a projector, a display device, or a TV).

The image resolution enhancement apparatus can confirm whether metadata related to the loaded image data exists as a field of the corresponding image data or a related manifest file (step S420). The manifest file can be received together or via separate channels when the image data is data received through wired or wireless communication from an external device.

When there is no metadata for the loaded image, the image resolution enhancement apparatus can request the metadata generation device 300 to generate metadata for the corresponding image data (step S421). In order to request the metadata generation, the image resolution enhancement apparatus can transmit the image data or transmit a unique identifier of the corresponding image data to the metadata generation device 300. For example, the unique identifier can be an identifier assigned by the content creator when generating the content. Accordingly, in the case of the image data distributed to a plurality of users from a content provider such as a content delivery network (CDN), the image resolution enhancement apparatus can request the metadata generation device 300 to generate metadata without transmitting the image data.

The image resolution enhancement apparatus can determine a super resolution model to be applied in order to enhance the resolution of each image of the still image or the moving image by analyzing the metadata (step S430).

The metadata can be included in a manifest file to be applied to a specific image or stored in a specific field of the corresponding still image data or moving image data.

The metadata related to the moving image data can be included in the manifest file of the configuration as in FIG. 5 as one embodiment, and an identifier of the super resolution model to be applied to each image in the moving image data can be stored for each image.

In an embodiment, explaining the metadata of the moving image data with reference to FIG. 5, information 510 including an identifier of a super resolution model to be applied to a first image with respect to the moving image data composed of two images, and information 520 including an identifier of a super resolution model to be applied to a second image among the two images, can be stored in the metadata. Further, when a plurality of super resolution models are applied to a single image, the identifiers of the corresponding plurality of super resolution models and a weighting factor of the processing result of each super resolution model can be stored in the metadata 510.

In another embodiment, when the moving image data is composed of a plurality of groups of pictures (GOPs), the moving image data can be stored in the metadata such that the same super resolution model is applied to the same group of pictures. In this case, different groups of pictures can be stored in the metadata such that different super resolution models are applied according to the determination result of the different metadata generation devices 300.

Referring to FIG. 7, when a super resolution model #2 is stored in the metadata as a super resolution model to be applied to a first group of pictures 721 in moving image data 710 composed of a plurality of groups of pictures 711 and 713, the image resolution enhancement apparatus can generate a high resolution image by applying the same super resolution model #2 to all the images in the first group of pictures 721. When a plurality of super resolution models are stored in the metadata as super resolution models to be applied to a group of pictures, the image resolution enhancement apparatus can generate a high resolution image by applying the same plurality of super resolution models to all images of the same group of pictures 723 by using a weighting factor.

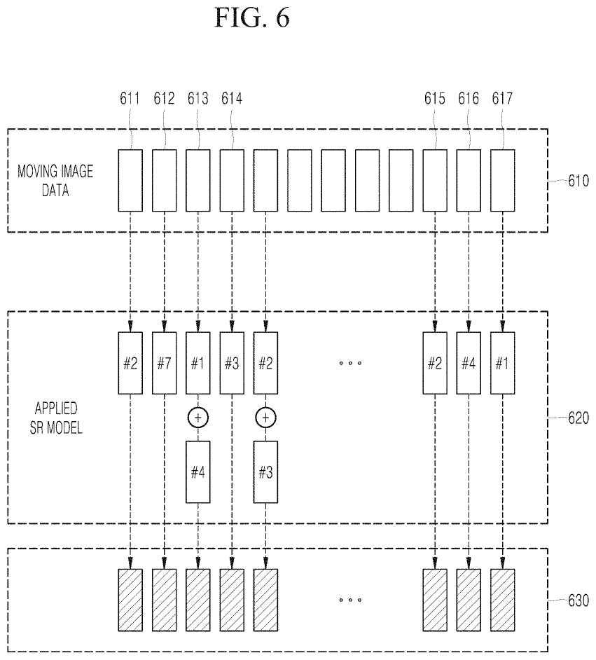

Referring to FIG. 6, the image resolution enhancement apparatus can select the super resolution model #2 as a super resolution model to be applied to the first image 611 in the moving image data 610 by analyzing metadata from a group composed of a plurality of super resolution models, and apply the super resolution model #2 to the image 611 to be processed.

When the super resolution model to be applied to the image is stored in the metadata as a plurality of super resolution models, the image resolution enhancement apparatus can synthesize the result of applying the plurality of super resolution models to the image to be processed by using the weighting factor stored in the metadata (step S453), and generate a final high resolution image (step S460).

Referring to FIG. 6, the image resolution enhancement apparatus can select a super resolution model #1 and a super resolution model #4 as super resolution models to be applied to a third image 613 in the moving image data 610 by analyzing the metadata from the group composed of the plurality of super resolution models, and generate the result of applying each of the selected super resolution models to the image 613 to be processed as a final high resolution image based on the weighting factor. Specifically, the metadata of a format as in FIG. 5 can include the following code as part of the metadata.

<FRAME>

<FRAME_ID>3</FRAME_ID>

<SRNET net_id=1, net_weight=0.7/>

<SRNET net_id=4, net_weight=0.3/>

</FRAME>

In this case, a final high resolution image can be generated by synthesizing the images of the result of applying weighting factors 0.7 and 0.3 to a first intermediate high resolution image generated by applying the super resolution model #1 to the third image 613 in the moving image data 610 having the frame ID of 3 and a second intermediate high resolution image generated by applying the super resolution model #4, respectively.

As one embodiment, the metadata related to the still image data or the moving image data can be included in a header area of the image data, and in the case of the moving image data, an identifier of a super resolution model to be applied to each image in the moving image data can be stored in a header area of each image in the moving image data or a header area of each group of pictures (GOP) for each image or each group of pictures (GOP). For example, in the case of moving image data of a MP4 file system, the identification information and weighting factor of the super resolution model to be applied to the image can be stored in a sample table (stb1) of the area classified as a moov, which is a metadata area, or a picture header area for each image. In the case of a still image, for example, a still image in JPEG format, the identification information and weighting factor of the super resolution model to be applied to the image can be stored in a specific field of the 0th IFD area of the APP1 as an exchangeable image file format (Exif) together with a predetermined tag. For example, if the metadata is stored as ‘Net#2/W0.3, Net#3/W0.7’ in the UserComment field of the 0th IFD area of the Exif data of the still image in JPEG format, the image resolution enhancement apparatus can generate, as a final high resolution image, an image synthesized by respectively applying the weighting factors 0.3 and 0.7 to the result of the super resolution model #2 and the result of the super resolution model #3 for the image to be processed.

The metadata can include a hash value of the image data generated based on the metadata. Accordingly, when confirming the metadata of the loaded image data (step S420), the image resolution enhancement apparatus can determine whether metadata suitable for (related to) the loaded image data exists by comparing the hash value of the metadata with a hash value of the loaded image data.

The image resolution enhancement apparatus can select a super resolution model to be applied to the image to be processed based on the analysis result of the metadata (step S440), and then process the image according to the selected super resolution model (step S451, S453) and obtain a high resolution image (step S460).

The image resolution enhancement apparatus can receive and store a plurality of super resolution models in advance from the content provision device 200 or the metadata generation device 300, or receive the plurality of super resolution models together with the image data from the content provision device 200. Accordingly, the image resolution enhancement apparatus can select the super resolution model to be applied to the image to be processed in the metadata based on the identifier of the super resolution model set in the analyzed metadata.

Referring to FIG. 6, the image resolution enhancement apparatus can select the super resolution model #2 as a super resolution model to be applied to the first image 611 in the moving image data 610 by analyzing metadata from a group composed of a plurality of super resolution models, and apply the super resolution model #2 to the image 611 to be processed.

When the super resolution model to be applied to the image is stored in the metadata as a plurality of super resolution models, the image resolution enhancement apparatus can synthesize the result of applying the plurality of super resolution models to the image to be processed by using the weighting factor(s) stored in the metadata (step S453) and generate a final high resolution image (step S460).

Referring to FIG. 6, the image resolution enhancement apparatus can select the super resolution model #1 and the super resolution model #4 as super resolution models to be applied to the third image 613 in the moving image data 610 by analyzing metadata from a group composed of a plurality of super resolution models, and generate the result of applying each of the super resolution model #1 and the super resolution model #4 to the image 613 to be processed as a final high resolution image based on the weighting factor.

The image resolution enhancement apparatus can store, in a buffer or another storage, the high resolution images generated for the moving image data as final high resolution images corresponding to a predetermined reference, for example, the images corresponding to 3 seconds or 90 frame images (step S470), and sequentially output the final high resolution image from the buffer after a reference section has elapsed or after the buffer has been filled to a certain capacity. The buffer preferably resides in the image resolution enhancement apparatus or can reside at another location.

The image resolution enhancement apparatus can output the images outputted from the buffer to a display of the image resolution enhancement apparatus, or output and transmit the images to an apparatus connected with the image resolution enhancement apparatus.

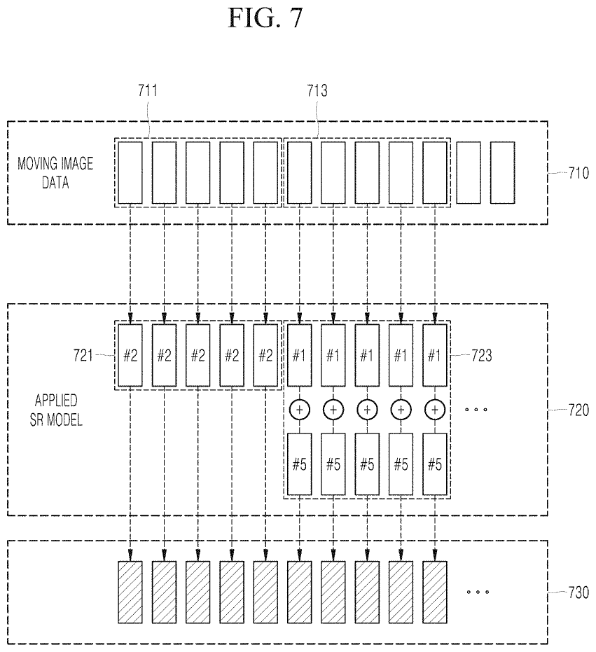

FIG. 8 is a flowchart for explaining a method for generating metadata of the metadata generation device 300 according to an embodiment of the present disclosure.

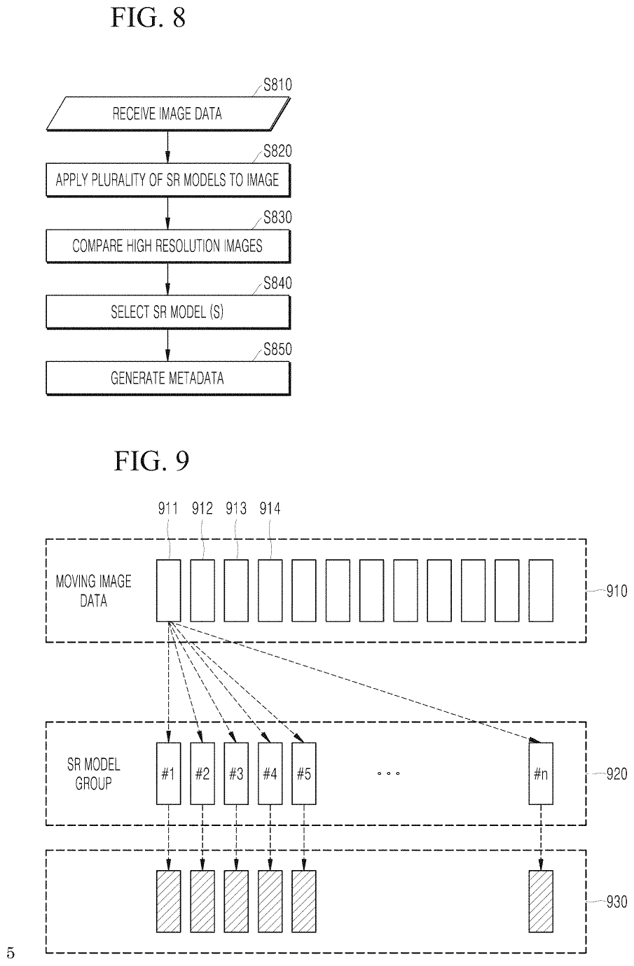

Further, FIG. 9 is a diagram for explaining a process in which the method for generating the metadata according to the embodiment of the present disclosure described in FIG. 8 is performed on moving image data.

The metadata generation device can have the same configuration as that of the metadata generation device 300 in FIGS. 1 and 2. First, the metadata generation device can receive image data 910 (step S810). The image data can be received from the image resolution enhancement apparatus or the content provision device 200, or image data received in the metadata generation device based on unique identification information of the image data transmitted from the image resolution enhancement apparatus together with a request for metadata generation. Further, the image data can be still image data composed of a single image or moving image data 910 composed of a plurality of images.

The metadata generation device can apply a plurality of super resolution models retained to each image of the received image data (step S820), and based on the result of comparing the generated high resolution images (step S830) can determine a super resolution model most suitable for the image processed (step S840).

In an embodiment, the metadata generation device can select, from among the retained plurality of super resolution models, a super resolution model of which the high resolution conversion quality is to be compared, based on performance information of the image resolution enhancement apparatus received from the image resolution enhancement apparatus. The performance information of the image resolution enhancement apparatus can include processor performance information such as a CPU or a GPU of the image resolution enhancement apparatus, memory performance and capacity information, or AI computation accelerator information. For example, if performance of the image resolution enhancement apparatus that requests metadata generation is low, the metadata generation device can apply, to the image, the super resolution models excluding super resolution models having a complexity of a certain level or more among the retained super resolution models, and compare the results.

Referring to FIG. 9, the metadata generation device can compare the quality of high resolution images 930 generated by applying each of a plurality of super resolution models of a super resolution model group 920 to an image 911 to be processed of the received moving image data 910. A quality comparison of the high resolution images can also compare the quality by using a recognition-based method such as a mean opinion score (MOS) as well as a distortion-based quality comparison method such as a peak signal-to-noise ratio (PSNR) or a Structural Similarity Index (SSIM).

In an embodiment, when the moving image data is composed of a plurality of groups of pictures (GOP), the quality of the high resolution images generated by applying each of the plurality of super resolution models of the super resolution model group can be compared for each group of picture. In this case, based on the result of comparing the quality of the high resolution images generated by applying each of the plurality of super resolution models to an intra frame of each group of picture, a super resolution model to be applied to the group of pictures including the corresponding intra frame can be determined.

Accordingly, since the same group of pictures can be a similar scene in the case of moving image data encoded into a group of pictures composed of an intra frame and an inter frame based on a scene change, it is possible to reduce the time taken for generating metadata of the moving image data, and to use the reduced resource necessary for generating an instance of the super resolution model even in the super resolution processing of the image resolution enhancement apparatus, which is advantageous for computation.

The metadata generation device can store the identification information and the weighting factor of the determined super resolution model together with the identifier indicating that the super resolution model is to be applied to the metadata for each image or for each group of picture. For example, when storing the identification information and weighting factor of the super resolution model in the manifest file in XML format as in FIG. 5 for each image, the metadata generation device can use the identifier ‘<FRAME>’ to mean that the super resolution model is to be applied for each image, and use the identifier ‘<GOP>’ to mean that the super resolution model is to be applied for each group of picture.

For example, in an embodiment, the metadata related to the still image data or the moving image data can be included in a header area of the image data, and in the case of the moving image data, an identifier of a super resolution model to be applied to each image in the moving image data can be stored in the header area of each image in the moving image data or the header area of each group of picture (GOP) for each image or each group of picture (GOP).

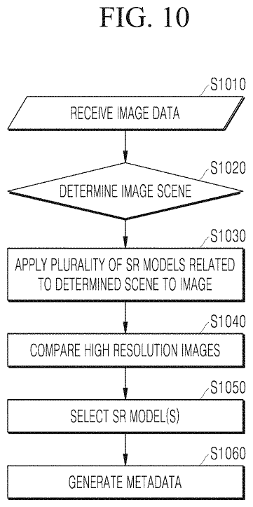

FIG. 10 is a flowchart for explaining a method for generating metadata of the metadata generation device 300 according to an embodiment of the present disclosure.

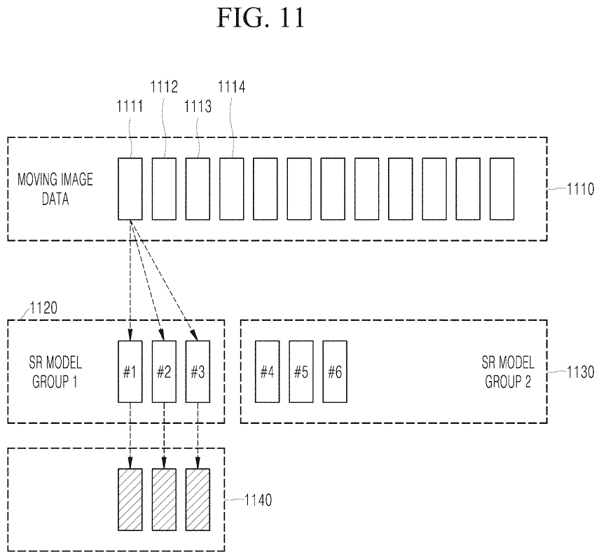

Further, FIG. 11 is a diagram for explaining a process in which the method for generating the metadata according to the embodiment of the present disclosure described in FIG. 10 is performed on moving image data.

In the following, portions overlapping with the description of FIGS. 1 to 9 will be omitted or may be brief.

The metadata generation device can have the same configuration as that of the metadata generation device 300 in FIGS. 1 and 2.

Referring to FIG. 10, the metadata generation device can receive image data 1110 (step S1010). The image data can be received from the image resolution enhancement apparatus or the content provision device 200, or image data received in the metadata generation device based on unique identification information of the image data transmitted from the image resolution enhancement apparatus together with a request for metadata generation. Further, the image data can be still image data composed of a single image or moving image data 910 composed of a plurality of images. The metadata generation device can determine a context with respect to an image to be processed of the received image data (step S1020), and based on the determined context can select a super resolution model of which the high resolution conversion quality is to be compared and apply the selected super resolution model to the image to be processed (step S1030). For the context determination, a super resolution model and another separate image processing artificial neural network can be used.

For example, referring to FIG. 11, the metadata generation device can store a super resolution model group 1 (1120) previously classified as having an excellent high resolution image conversion quality of an image including a human, and a super resolution model group 2 (1130) previously classified as having an excellent high resolution image conversion quality of an image including a natural scene. When determining that the image to be processed includes a human, the metadata generation device can compare the quality of the high resolution images 1140 generated by applying only the super resolution models (#1 to #3) belonging to the super resolution model group 1 to the image 1111 to be processed (step S1040), determine a super resolution model to be applied to the image to be processed (step S1050), and store the identification information and weighting factor of the determined super resolution model in the metadata (step S1060).

The present disclosure described above can be embodied as computer-readable codes on a medium on which a program is recorded. The computer readable medium includes all types of recording devices in which data readable by a computer system readable can be stored. Examples of the computer readable medium include a Hard Disk Drive (HDD), a Solid State Disk (SSD), a Silicon Disk Drive (SDD), a ROM, a RAM, a CD-ROM, a magnetic tape, a floppy disk, an optical data storage device, etc. Moreover, the computer can include a processor 180 of a terminal.

The computer programs can be those specially designed and constructed for the purposes of the present disclosure or they can be of the kind well known and available to those skilled in the computer software arts. Examples of computer programs can include both machine codes, such as produced by a compiler, and higher-level codes that can be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps can be performed in any suitable order, unless expressly indicated otherwise. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and form factors within the scope of the appended claims or equivalents thereof.

It should be apparent to those skilled in the art that various substitutions, changes and modifications which are not exemplified herein but are still within the spirit and scope of the present disclosure can be made.

What is claimed is:

1. A method for enhancing a resolution of an image, the method comprising:
loading, by an image resolution enhancement apparatus, image data comprising a low resolution image and metadata of the image data;
analyzing the metadata comprising information related to an image processing artificial neural network to be applied to the low resolution image in the image data;
selecting the image processing artificial neural network to be applied to the low resolution image from an image processing artificial neural network group comprising a plurality of image processing artificial neural networks, based on the metadata; and
generating, by the image resolution enhancement apparatus, a high resolution image by processing the low resolution image according to the selected image processing artificial neural network.

2. The method of claim 1,
wherein the image data is moving image data composed of a plurality of low resolution images, and
wherein the selecting of the image processing artificial neural network comprises:
selecting different image processing artificial neural networks to be respectively applied to at least two different low resolution images of the moving image data, based on the metadata.

3. The method of claim 2, further comprising:
after the generating of the high resolution image,
storing the generated high resolution image in a buffer during a predetermined reference time or a predetermined reference period; and
sequentially outputting the high resolution image from the buffer.

4. The method of claim 1,
wherein the image data is moving image data composed of a plurality of groups of pictures (GOP), and
wherein the selecting of the image processing artificial neural network comprises:
selecting different image processing artificial neural networks to be respectively applied to at least two different groups of pictures of the moving image data, based on the metadata.

5. The method of claim 1,
wherein the metadata comprises a first weighting factor and a second weighting factor respectively related to a first image processing artificial neural network and a second image processing artificial neural network, and
wherein the selecting of the image processing artificial neural network comprises selecting the first image processing artificial neural network and the second image processing artificial neural network to be applied to the low resolution image, based on the metadata.

6. The method of claim 5,
wherein the generating of the high resolution image comprises:
generating a first intermediate high resolution image and a second intermediate high resolution image by respectively applying the first image processing artificial neural network and the second image processing artificial neural network to the low resolution image; and
generating the high resolution image by synthesizing an image of a result of the applying the first weighting factor to the first intermediate high resolution image and an image of a result of the applying the second weighting factor to the second intermediate high resolution image.

7. The method of claim 1, further comprising:
prior to the analyzing the metadata,
transmitting the image data to a metadata generation server apparatus; and
receiving the metadata comprising information related to the image processing artificial neural network to be applied to the low resolution image in the image data.

8. A computer readable recording medium comprising a computer program stored on the computer readable recording medium, wherein the computer program comprises computer-executable instructions for performing the method of claim 11, when executed by a computer.

9. A method for generating metadata for enhancing a resolution of an image, the method comprising:
receiving, by a metadata generation device from a user terminal, image data comprising a low resolution image;
generating a plurality of high resolution images by processing the low resolution image according to a plurality of image processing artificial neural networks;
determining at least one image processing artificial neural network to be applied to the low resolution image by comparing a quality of the plurality of high resolution images; and
generating, by the metadata generation device, metadata comprising identification information of the determined at least one image processing artificial neural network.

10. The method of claim 9, further comprising:
determining a context of the low resolution image by processing the low resolution image according to an artificial neural network for determining the context; and
generating the plurality of high resolution images by processing the low resolution image according to the plurality of image processing artificial neural networks which is preset in relation to the determined context.

11. The method of claim 9, further comprising:
prior to the generating of the plurality of high resolution images,
receiving performance information of the user terminal; and
selecting a plurality of image processing artificial neural networks based on the performance information,
wherein the generating of the plurality of high resolution images comprises generating the plurality of high resolution images by processing the low resolution image according to the selected plurality of image processing artificial neural networks.

12. An apparatus for enhancing image resolution, the apparatus comprising:
a processor; and
a memory operatively coupled with the processor and configured to store metadata of image data,
wherein the memory stores computer-executable codes configured to cause the processor to generate a high resolution image by loading the image data comprising a low resolution image and the metadata of the image data, and processing the low resolution image according to an image processing artificial neural network model to be applied to the low resolution image from an image processing artificial neural network model group comprising a plurality of image processing artificial neural network models based on the metadata, when executed at the processor.

13. The apparatus of claim 12,
wherein the metadata comprises a first weighting factor and a second weighting factor respectively related to a first image processing artificial neural network and a second image processing artificial neural network, and
wherein the memory further stores computer-executable codes configured to cause:
generation of a first intermediate high resolution image and a second intermediate high resolution image by respectively applying the first image processing artificial neural network and the second image processing artificial neural network to the low resolution image, and
generation of the high resolution image by synthesizing an image of a result of the applying the first weighting factor to the first intermediate high resolution image and an image of a result of the applying the second weighting factor to the second intermediate high resolution image, based on the metadata.

14. The apparatus of claim 12,
wherein the image data is moving image data composed of a plurality of low resolution images, and
wherein the memory further stores computer-executable codes configured to cause:
generation of the high resolution image by processing the low resolution image according to at least two different image processing artificial neural network models to be respectively applied to at least two different low resolution images of the moving image data, or to be respectively applied to at least two different groups of pictures (GOP), based on the metadata.

15. The apparatus of claim 12,
wherein the memory further stores computer-executable codes configured to cause:
generation of a plurality of artificial neural network instances based on the plurality of image processing artificial neural network models, and
delivery of the low resolution image to any one artificial neural network instance among the plurality of artificial neural network instances based on the metadata.

16. The apparatus of claim 12,
wherein the memory further stores computer-executable codes configured to cause:
selective generation of an artificial neural network instance based on any one artificial neural network model among the plurality of image processing artificial neural network models based on the metadata, and
delivery of the low resolution image to the generated artificial neural network instance.

17. The apparatus of claim 12,
wherein the metadata further comprises a hash value related to the image data, and
wherein the memory further stores computer-executable codes configured to cause comparison of the hash value included in the metadata with a hash value of the loaded image data.
